(19) United States
(12) Patent Application Publication
(10) Pub. No.: US 2011/0220441 A1
(43) Pub. Date: Sep. 15, 2011

(54) DISC BRAKE BACKING PLATE AND METHODS OF MANUFACTURING THE SAME

(76) Inventor: Jim Zewei Zhang, Irvine, CA (US)

(21) Appl. No.: 12/268,384

(22) Filed: Nov. 10, 2008

(30) Foreign Application Priority Data
Oct. 31, 2008 (CN) 200810197495.6

(51) Int. Cl. F16D 65/04; B23P 11/00

(52) U.S. Cl. 188/250 B; 29/428

(57) ABSTRACT

A disc brake pad is composed of a backing plate and a friction material. The adhesion of the backing plate and the friction material is enhanced in the present invention by multiple recesses on the surface of the backing plate that is attached to the friction material. One of the advantages of the present invention is the ease of manufacturing. In one of the preferred methods of manufacturing, a matrix of recesses (2) is first impressed onto the steel sheet by a stamping press. The existing method of producing a traditional backing plate, i.e., stamping out the backing plate profile and the bores, may then be applied.

This application claims the benefit of Chinese Patent Application No. 200810197495.6, filed on Oct. 31, 2008, which is relied upon and incorporated by reference herein.

### FIELD OF INVENTION

The present invention concerns a novel backing plate of a brake pad of a disc brake to enhance the adhesion between the backing plate and the friction material.

### BACKGROUND OF THE INVENTION

When a disc brake is applied, the caliper pushes the friction material against the rotor via the backing plate. In reference to the car, the friction that the rotor applied to the friction material is in the direction of the motion of the rotor. The caliper applies a force of the same magnitude but in the opposite direction on the backing plate to keep the brake pad stationary. The adhesion between the backing plate and the friction material must sustain the shearing force caused by the friction on the friction material and the caliper on the backing plate.

### DESCRIPTION OF RELATED ART

There have been many efforts in recent years to increase the shearing strength of the joint between the backing plate and the friction material. U.S. Pat. No. 4,991,697 (1991) uses a mesh net on the backing plate; U.S. Pat. No. 6,390,251 (2002) uses dimples on the backing plate; U.S. Pat. No. 5,129,487 (1992) uses specially shaped cavities in the backing plate; and U.S. Pat. No. 6,843,095 (2005) uses burrs on the backing plate to engage (i.e., anchor onto) the friction material to increase the adhesion between the backing plate and the friction material.

The challenge in this area is to increase the adhesion between the backing plate and the friction material while neither decrease the strength of the backing plate itself nor increase the production cost beyond what the market is willing to accept.

### SUMMARY OF THE INVENTION

The present invention uses multiple recesses (2) on the backing plate to increase the adhesion between the backing plate and the friction material, and thus increase the shearing strength of the brake pad.

In one of the preferred arrangements, a uniform matrix of recesses (2) is applied to the backing plate, therefore producing increased adhesion uniformly throughout the backing plate.

### BRIEF DESCRIPTION OF THE DRAWINGS

FIG. 1 is the plan view of the backing plate showing the matrix of recesses (2).

FIG. 2 is a cross-sectional side view of FIG. 1.

FIG. 3 is the enlargement of a recess (2) on the plate shown in FIG. 2 as “A”.

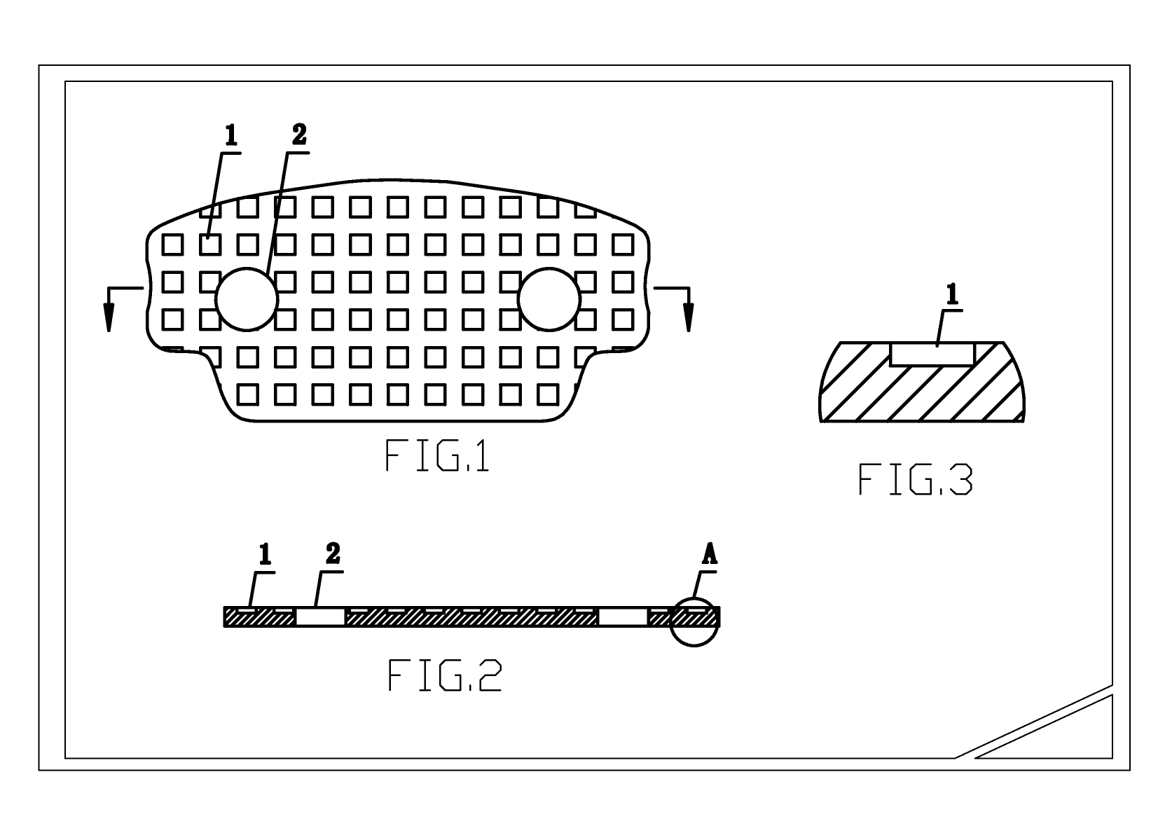

### DETAILED DESCRIPTION OF THE PREFERRED EMBODIMENT

This present invention places a matrix of recesses (2) onto the backing plate therefore increasing the ability to withstand shearing force between the backing plate and the friction material by (i) increased surface area and (ii) the creation of engagement, i.e., friction locking, between the recesses (2) in the backing plate and the corresponding protrusions on the friction material.

The placement and size of the recesses (2) is critical in enhancing the adhesion, which is measured by (i) the retention area and (ii) the shearing strength.

The retention area is defined as the area where the friction material that remains on the backing plate after a shearing force is applied on the friction material enough to cause the friction material to break away from the backing plate.

The shearing strength is defined as the maximum shear stress that the joint between the backing plate and the friction material can withstand without rupture.

When the recess area is greater than 9 mm², or when the density of the recesses (2) is less than 2.7/cm², the shearing strength starts to decrease significantly. Likewise, when the recess area is less than 2.5 mm², the shearing strength also starts to decrease.

When the density of the recesses (2) is greater than 7 cm², the shearing strength is not obviously enhanced. Since distortion is likely to occur with the density over 7 cm² during stamping pressing, and greater density of recesses (2) cause the waste of the friction material material, the density of recesses (2) should be limited to no greater than 7 cm².

The preferred depth of the recesses (2) is 1.5-3 mm. When the depth is greater than 3 mm, stamping pressing would distort the backing plate, affecting the strength thereof. Deeper recesses (2) also cause the waste of the friction material material. When the recesses (2) are shallower than 1.5 mm, the shearing strength would decrease.

In conclusion, in preferred embodiment, the effective area of recesses (2) is 2.5-9 mm²; the density of the recesses (2) 2.7-7 cm²; and depth of the recesses (2) is 1.5-3 mm. In aforementioned range, the recess matrix increases the shearing strength of the brake pad from 5-6 MPa of a regular flat backing plate to no less than 8 MPa of this present invention, while not weakening the overall strength and performance of the backing plate.

Additionally, the preferred shape of the recesses (2) is square, and the best matrix arrangement is that of a square matrix, i.e., the distance between neighboring recesses (2) remains equal throughout the plate (to cause uniform increase of the adhesion) and the crossing matrix lines connecting neighboring recesses (2) remain perpendicular.

One of the most significant values of the present invention is it may be easily adapted in the existing brake pad plants at low cost. First, manufacturers only need to apply stamping pressing to the steel sheet to produce the recesses prior to stamping. After the production of recesses on the steel sheet, the traditional manufacturing process (i.e., manufacturing the backing plate without the recesses) may be applied without modification. Second, since the location of the recesses (2) is unimportant, the stamping pressing location and stamping location are independent. Therefore, the location of the matrix is not a factor in determining the stamping location.

In case that stamping pressing the recesses on a large steel sheet is a problem, recesses may be pressed onto the backing plate profile.

As the increase of adhesion, i.e., the shearing strength, increases the reliability of the brake pad, the safety of vehicle passengers is consequently increased.

### REMARKS

The substitute specification contains no new matter.

Only line spacing is changed per the request of the Notice to File Corrected Application Papers. Therefore no Marked Up Version was included.

I claim:

1. A disc brake backing plate comprising a steel backing plate having a plurality of recesses on a first surface thereof for securing a friction material to the first surface.

2. The disc brake backing plate according to claim 1 wherein the recesses are arranged in the form of a matrix.

3. The disc brake backing plate according to claim 2 wherein the matrix is a square matrix.

4. The disc brake backing plate according to claim 1 wherein the recesses are identical in shape, size, and depth.

5. The disc brake backing plate according to claim 4 wherein the area of the recesses is between 2.5 mm² and 9 mm².

6. The disc brake backing plate according to claim 4 wherein the density of the recesses between 2.7 cm² and 7 cm².

7. The disc brake backing plate according to claim 4 wherein the depth of the recesses is between 1.5 mm and 3 mm.

8. The disc brake backing plate according to claim 4 wherein the recesses are in the shape squares.

9. A method of manufacturing a disc brake backing plate for securing a friction material to a first surface thereof, the method comprising:
a. Producing the recesses on the first surface of a steel sheet with a stamping press with a specially designed dye; and
b. Producing the backing plate profile and bores therein.

10. A method of manufacturing a disc brake backing plate for securing a friction material to a first surface thereof, the method comprising:
a. Producing a backing plate profile and bores therein; and
b. Producing the recesses on the first surface of the backing plate with a stamping press with a specially designed dye.
